(19) United States
(12) Patent Application Publication
(10) Pub. No.: US 2019/0153932 A1
(43) Pub. Date: May 23, 2019

(54) MODEL BASED CONTROL OF VALVES FOR TURBINES IN AN ENGINE

(71) Applicant: GM GLOBAL TECHNOLOGY OPERATIONS LLC, Detroit, MI (US)

(72) Inventors: Yue-Yun Wang, Troy, MI (US); Joerg Bernards, Katzenelnbogenf (DE)

(73) Assignee: GM GLOBAL TECHNOLOGY OPERATIONS LLC, Detroit, MI (US)

(21) Appl. No.: 15/819,406

(22) Filed: Nov. 21, 2017

(51) Int. Cl. F02B 37/18; F02D 41/26; F02D 41/24; F02B 37/013

(52) U.S. Cl. CPC F02B 37/183; F02B 37/013; F02D 41/2409; F02D 41/26

(57) ABSTRACT

An engine assembly includes an engine, a first turbine operatively connected to the engine, a first valve configured to modulate flow to the first turbine, a controller configured to transmit a primary command signal to the first valve and at least one sensor configured to transmit a sensor feedback to the controller. The controller is configured to obtain a first model output based at least partially on a desired total compressor pressure ratio (β̅_{c}). A first delta factor is obtained based at least partially on the desired total compressor pressure ratio (β̅_{c}) and the sensor feedback. The controller is configured to obtain a first valve optimal position based at least partially on the first model output and the first delta factor. The output of the engine is controlled by commanding the first valve to the first valve optimal position.

### INTRODUCTION

The disclosure relates generally to control of an engine assembly, and more particularly, to model based control of valves modulating flow to one or more turbines in the engine assembly. A turbine utilizes pressure in an exhaust system of the engine to drive a compressor to provide boost air to the engine. The boost air increases the flow of air to the engine, resulting in increased output for the engine. The flow of air to the turbine may be modulated with the use of control valves. Optimizing modulation of multiple valves in a single or two-stage turbocharger for a boosted engine is a challenging endeavor.

### SUMMARY

Disclosed herein is an engine assembly having an engine, a first turbine operatively connected to the engine, a first valve configured to modulate flow to the first turbine, and a controller configured to transmit a primary command signal to the first valve. At least one sensor is configured to transmit a sensor feedback to the controller. The controller has a processor and a tangible, non-transitory memory on which is recorded instructions. Execution of the instructions by the processor causes the controller to obtain a first model output based at least partially on a desired total compressor pressure ratio (β̅_{c}). A first delta factor is obtained based at least partially on the desired total compressor pressure ratio (β̅_{c}) and the sensor feedback. The controller is configured to obtain the first valve optimal position (u_{BV}^{LP}) based at least partially on the first model output and the first delta factor. The engine output is controlled by commanding the first valve to the first valve optimal position (u_{BV}^{LP}), via the controller.

The controller may be configured to determine the first valve optimal position (u_{BV}^{LP}) as at least one of a first look-up factor and a first polynomial function (ƒ₁ (x₁, x₂)) of a desired low pressure (hereinafter referred as “LP”) turbo speed (x₁=N̅ₜ^{LP}) and a modified total exhaust flow

$$( {x}_{2} = \frac{{W}_{x} \sqrt{{T}_{x 1}}}{{p}_{to}} ) .$$

The desired LP turbo speed (N̅ₜ^{LP}) is based partially on at least one of a second look-up factor and a second polynomial function (ƒ₂ (x₁, x₂)) of a desired LP compressor pressure ratio (x₁=β̅_{c}^{LP}) and a modified compressor flow

$$( {x}_{2} = \frac{{W}_{C} \sqrt{{T}_{a}}}{{p}_{a}} ) .$$

Here Pₜₒ is a turbine outlet pressure, Tₓ₁ is an mid-exhaust temperature, Wₓ is an exhaust flow, pₐ is an ambient pressure, Tₐ is an ambient temperature and W_{c} a fresh air flow.

Alternatively, the controller is configured to determine the first valve optimal position (u_{BV}^{LP}) as at least one of a third look-up factor and a third polynomial function (ƒ₃ (x₁, x₂)) of a modified LP compressor power

$$( {x}_{1} = \frac{{\overline{P}}_{w}^{LP}}{{p}_{to} \sqrt{{T}_{x 1}}} )$$

and a modified total exhaust flow

$$( {x}_{2} = \frac{{W}_{x} \sqrt{{T}_{x}}}{{p}_{to}} ) .$$

Here P̅_{w}^{LP} is an LP compressor power, pₜₒ is a turbine outlet pressure, Tₓ₁ is an mid-exhaust temperature, Wₓ is an exhaust flow and Tₓ is an exhaust temperature. The LP compressor power (P̅_{w}^{LP}) may be determined based at least partially on an LP compressor transfer rate (R_{c}^{LP}), an ambient temperature (Tₐ) and a fresh air flow (W_{c}). The LP compressor transfer rate (R_{c}^{LP}) may be determined as at least one of a fourth look-up factor and a fourth polynomial function (ƒ₄ (x₁, x₂)) of a desired LP compressor pressure ratio (x₁=β̅_{c}^{LP}) and a modified compressor flow

$$( {x}_{2} = \frac{{W}_{C} \sqrt{{T}_{a}}}{{p}_{a}} ) .$$

In a second embodiment, the assembly may include a second turbine operatively connected to the first turbine, with the first turbine being a relatively high pressure turbine and the second turbine being a relatively low pressure turbine. A second valve is operatively connected to the second turbine. The controller may be further configured to obtain a power-split distribution based at least partially on the desired total compressor pressure ratio (β̅_{c}). The power-split distribution is characterized by a desired LP compressor pressure ratio (β̅_{c}^{LP}) and a desired high pressure (hereinafter referred as “HP”) compressor pressure ratio (β̅_{c}^{HP}).

The controller is configured to obtain a second model output based at least partially on the desired HP compressor pressure ratio (β̅_{c}^{HP}). A second delta factor is obtained based at least partially on the desired HP compressor pressure ratio (β̅_{c}^{HP}) and the sensor feedback. The controller is configured to obtain a second valve optimal position (u_{BV}^{HP}) based at least partially on the second model output and the second delta factor. The output of the engine is controlled by commanding the second valve to the second valve optimal position (u_{BV}^{HP}), via the controller.

The controller may be configured to determine the second valve optimal position (u_{BV}^{HP}) as at least one of a fifth look-up factor and a fifth polynomial function (ƒ₅ (x₁, x₂)) of a desired HP turbo speed (x₁=N̅ₜ^{HP}) and a modified total exhaust flow

$$( {x}_{2} = \frac{{W}_{x} \sqrt{{T}_{x}}}{{p}_{x 1}} ) ,$$

where pₓ₁ is mid-exhaust pressure, Tₓ is exhaust temperature, Wₓ is an exhaust flow. The desired HP turbo speed (N̅ₜ^{HP}) is based in part on at least one of a sixth look-up factor and a sixth polynomial function (ƒ₆ (x₁, x₂)) of a desired HP compressor pressure ratio (x₁=β̅_{c}^{HP}) and a modified fresh air flow

$$( {x}_{2} = \frac{{W}_{C} \sqrt{{T}_{1}}}{{\overline{β}}_{c}^{LP} {p}_{a}} ) ,$$

where pₐ is an ambient pressure, T₁ is an LP compressor outlet temperature and W_{c} a fresh air flow.

Alternatively, the controller may be configured to determine the second valve optimal position (u_{BV}^{HP}) as at least one of a seventh look-up factor and a seventh polynomial function (ƒ₇ (x₁, x₂)) of a modified HP compressor power

$$( {x}_{1} = \frac{{\overline{P}}_{w}^{HP}}{{p}_{x 1} \sqrt{{T}_{x}}} )$$

and a modified total exhaust flow

$$( {x}_{2} = \frac{{W}_{x} \sqrt{{T}_{x}}}{{p}_{x 1}} ) .$$

Here P̅_{w}^{HP} is a HP compressor power, pₓ₁ is a mid-exhaust pressure, Tₓ is an exhaust temperature and Wₓ is an exhaust flow. The HP compressor power (P̅_{w}^{HP}) may be determined based at least partially on an HP compressor transfer rate (R_{c}^{HP}), an ambient temperature (Tₐ) and a fresh air flow (W_{c}). The HP compressor transfer rate (R_{c}^{HP}) may be obtained as at least one of an eighth look-up factor and an eighth polynomial function (ƒ₈ (x₁, x₂)) of a desired HP compressor pressure ratio (x₁=β̅_{c}^{HP}) and a modified fresh air flow

$$( {x}_{2} = \frac{{W}_{C} \sqrt{{T}_{1}}}{{\overline{β}}_{c}^{LP} {p}_{a}} ) .$$

Here T₁ is an LP compressor outlet temperature and pₐ is an ambient pressure.

Also disclosed herein is a method of controlling an output of an engine assembly having an engine, a first turbine operatively connected to the engine, a first valve configured to modulate flow to the first turbine, a controller configured to transmit a primary command signal to the first valve, and at least one sensor configured to transmit a sensor feedback to the controller. The controller has a processor and a tangible, non-transitory memory on which is recorded instructions. The method includes obtaining a first model output based at least partially on a desired total compressor pressure ratio (β̅_{c}), and obtaining a first delta factor based at least partially on the desired total compressor pressure ratio (β̅_{c}) and the sensor feedback. The method includes obtaining a first valve optimal position (u_{BV}^{LP}) based at least partially on the first model output and the first delta factor and controlling an output of the engine by commanding the first valve to the first valve optimal position (u_{BV}^{LP}), via the primary command signal.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary view of an engine assembly having a controller;

FIG. 2 is a flowchart for a method executable by the controller of FIG. 1;

FIG. 3 is a diagram of a control structure embodying the method of FIG. 2, in accordance with a first embodiment; and

FIG. 4 is a diagram of another control structure embodying the method of FIG. 2, in accordance with a second embodiment.

### DETAILED DESCRIPTION

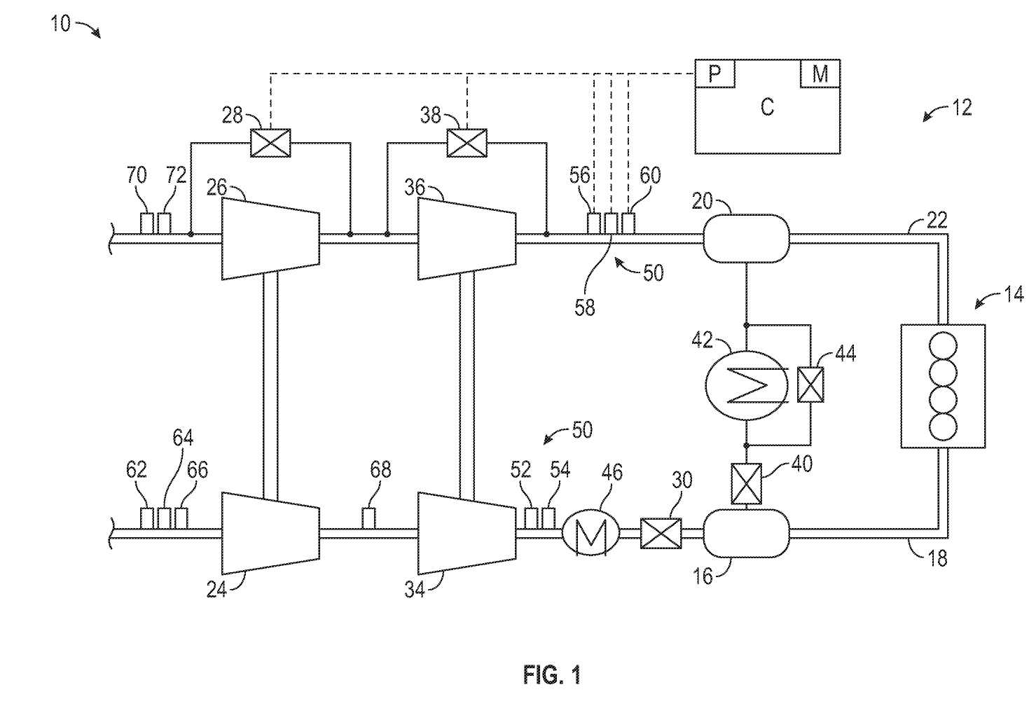

Referring to the drawings, wherein like reference numbers refer to like components, FIG. 1 schematically illustrates a device 10 having an engine assembly 12. The device 10 may be a mobile platform, such as, but not limited to, standard passenger car, sport utility vehicle, light truck, heavy duty vehicle, ATV, minivan, bus, transit vehicle, bicycle, robot, farm implement, sports-related equipment, boat, plane, train or other transportation device. The device 10 may take many different forms and include multiple and/or alternate components and facilities.

Referring to FIG. 1, the assembly 12 includes an internal combustion engine 14, referred to herein as engine 14, for combusting an air-fuel mixture in order to generate output torque. The assembly 12 includes an intake manifold 16, which may be configured to receive fresh air from the atmosphere. The engine 14 may combust an air-fuel mixture, producing exhaust gases. The intake manifold 16 is fluidly coupled to the engine 14 and capable of directing air into the engine 14, via an air inlet conduit 18. The assembly 12 includes an exhaust manifold 20 in fluid communication with the engine 14, and capable of receiving and expelling exhaust gases from the engine 14, via an exhaust gas conduit 22. The engine 14 may be a spark-ignition engine, a compression-ignition engine, piston-driven or other type of engine available to those skilled in the art.

Referring to FIG. 1, the assembly 12 includes a first compressor 24 configured to be driven by a first turbine 26. The first compressor 24 is employed to compress the inlet air to increase its density to provide a higher concentration of oxygen in the air fed to the engine 14. The first turbine 26 includes a fixed geometry turbine. The assembly 12 includes a number of selectively controllable bypass valves, including a first valve 28 configured to modulate flow to the first turbine 26. An intake throttle valve 30 is fluidly connected to the air inlet conduit 18.

Referring to FIG. 1, the assembly 12 may have only one turbocharger (first compressor 24, first turbine 26), or may include a second turbocharger (second compressor 34, second turbine 36). The second compressor 34 is configured to be driven by the second turbine 36, and a second valve 38 configured to modulate flow to the second turbine 36. Because the inlet air for the second compressor 34 is caused to be at a relatively higher pressure than the inlet air for the first compressor 24, the first compressor 24 may be referred to as a low pressure compressor, and the second compressor 34 as a high pressure compressor. Likewise, the inlet air for the second turbine 36 is at a higher pressure than the inlet air for the first turbine 26, thus the second turbine 36 may be referred to as a high pressure (“HP”) turbine, and the first turbine 26 may be termed a low pressure (“LP”) turbine.

The assembly 12 may include an exhaust gas recirculation (EGR) system with multiple routes of recirculating exhaust gas. Referring to FIG. 1, the assembly 12 may include an EGR valve 40, an EGR cooler 42 and a cooler bypass 44. The EGR cooler 42 is employed to reduce the temperature of the re-circulated exhaust gases prior to mixing with air being admitted through the intake manifold 16. A charge air cooler 46 may be positioned on the high pressure side of the first compressor 24 and configured to dissipate some of the heat resulting from compression of the inlet air.

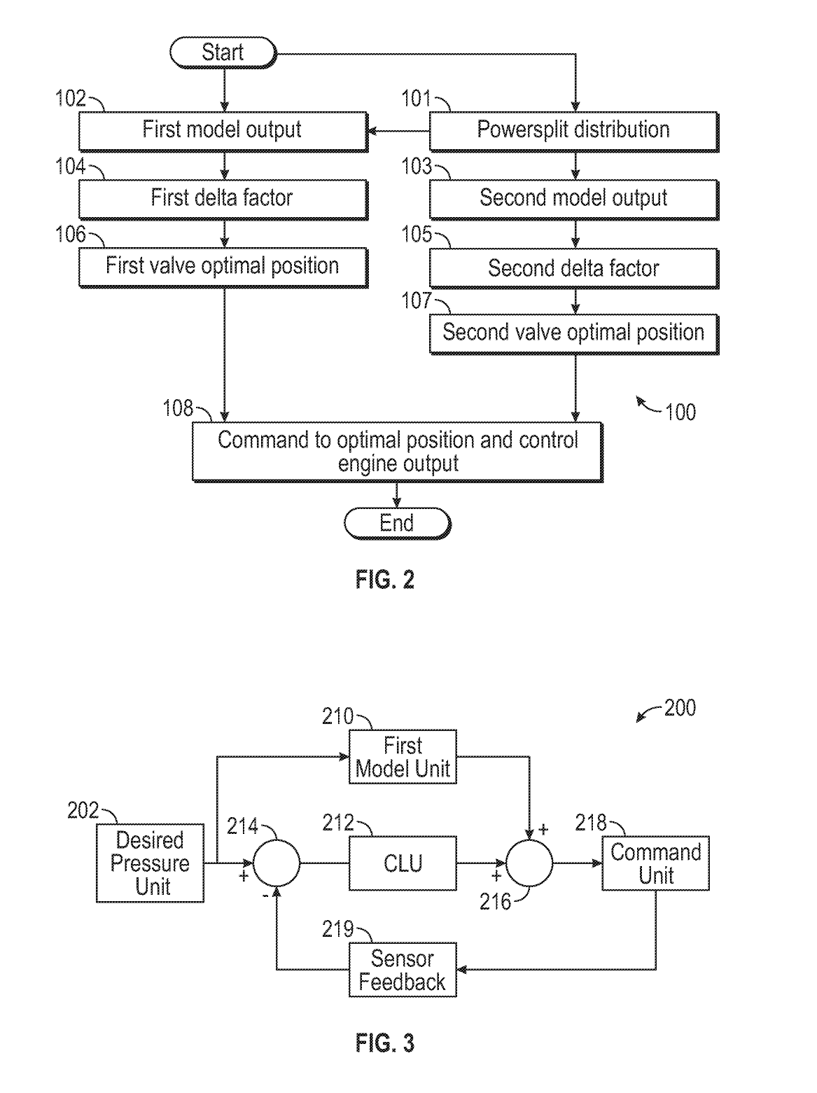

Referring to FIG. 1, the assembly 12 includes a controller C in communication (e.g., in electronic communication) with the engine 14. Referring to FIG. 1, the controller C includes at least one processor P and at least one memory M (or any non-transitory, tangible computer readable storage medium) on which are recorded instructions for executing method 100, shown in FIG. 2 and described below, for controlling an output of the engine 14. The memory M can store controller-executable instruction sets, and the processor P can execute the controller-executable instruction sets stored in the memory M. The controller C is programmed to receive a torque request from an operator input, such as through an accelerator or brake pedal (not shown), or an auto start condition or other source monitored by the controller C.

Referring to FIG. 1, the controller C is configured to receive sensor feedback from one or more sensors 50. The sensors 50 may include but are not limited to: an intake manifold pressure sensor 52, an intake manifold temperature sensor 54, an exhaust temperature sensor 56, an exhaust pressure sensor 58, an exhaust flow sensor 60, an ambient temperature sensor 62, an ambient pressure sensor 64, a fresh airflow sensor 66, an LP compressor outlet pressure sensor 68, a turbine outlet pressure sensor 70 and a turbine outlet temperature sensor 72. Additionally, various parameters may be obtained via “virtual sensing”, such as for example, modeling based on other measurements. For example, the intake temperature may be virtually sensed based on a measurement of ambient temperature and other engine measurements.

The method 100 below refers to a number of parameters that are obtained as at least one of an i^{th} look-up factor and an i^{th} polynomial function (ƒ₁ (x₁, x₂)) of a first factor (x₁) and a second factor (x₂)). This implies that the parameter may be obtained from a stored look-up table of the first factor (x₁) and the second factor (x₂)) or a polynomial function (ƒ₁ (x₁, x₂)) of the first factor (x₁) and the second factor (x₂)). The first factor (x₁) and the second factor (x₂) may be different for each of the parameters. Each of the polynomial functions (ƒ₁ (x₁, x₂)) may be represented by the respective first factor (x₁), the respective second factor (x₂) and a plurality of constants (a) as follows:

ƒ₁(x₁,x₂)=a₀+a₁x₁+a₂x₂+a₃x₁²+a₄x₂²+a₅x₁·x₂+ . . .

The plurality of constants (aᵢ) may be obtained by calibration.

Referring now to FIG. 2, a flowchart of the method 100 stored on and executable by the controller C of FIG. 1 is shown. The controller C of FIG. 1 is specifically programmed to execute the steps of the method 100. The method 100 need not be applied in the specific order recited herein. Furthermore, it is to be understood that some steps may be eliminated.

In accordance with a first embodiment, a first control structure 200 is shown in FIG. 3 for a single stage turbocharger. The first control structure 200 is configured to execute blocks 102, 104, 106 and 108 of method 100 of FIG. 2. In the first embodiment, the method 100 may begin with block 102, where the controller C is programmed or configured to obtain a first model output based at least partially on a desired total compressor pressure ratio (β̅_{c}). Referring to FIG. 3, the first control structure 200 includes a Desired Pressure Unit 202 that obtains and feeds the desired total compressor pressure ratio (β̅_{c}) into a First Model Unit 210, which produces a first model output (per block 102 of FIG. 2).

In block 104 of FIG. 2, the controller C is programmed to obtain a first delta factor based at least partially on the desired total compressor pressure ratio (β̅_{c}) and the sensor feedback (from one or more of the sensors 50 operatively connected to the controller C). The first delta factor represents a change in position of the first valve 28 that minimizes a difference between the desired total compressor pressure ratio (β̅_{c}) and a measured total compressor pressure ratio (β̅_{c}). Referring to FIG. 3, the Desired Pressure Unit 202 also feeds the desired total compressor pressure ratio (β̅_{c}) into a first summation unit 214, which receives sensor feedback 219 from the plurality of sensors 50. The first control structure 200 includes a Closed Loop Unit 212 (“CLU” in FIG. 3) that determines a first delta factor (per block 102 of FIG. 2) based at least partially on the desired total compressor pressure ratio (β̅_{c}) and the sensor feedback 219. The Closed Loop Unit 212 may be proportional-integral-derivative (PID) units, a model predictive control units (MPC) or other closed loop units available to those skilled in the art.

In block 106 of FIG. 2, the controller C is programmed to obtain the first valve position (u_{BV}^{LP}) based at least partially on the first model output and the first delta factor. Referring to FIG. 3, a Second Summation Unit 216 is configured to sum the output of the Closed Loop Unit 212 (the first delta factor) and the output of the First Model Unit 210 (the first model output) to determine the first valve optimal position (u_{BV}^{LP})(per block 106), which is inputted into a Command Unit 218.

The controller C may be configured to determine the first valve optimal position (u_{BV}^{LP}) as at least one of a first look-up factor (i.e., stored as a look-up table of the first factor (x₁) and the second factor (x₂)) and a first polynomial function (ƒ₁ (x₁, x₂)) of a desired LP turbo speed (x₁=N̅ₜ^{LP}) and a modified total exhaust flow

$$( {x}_{2} = \frac{{W}_{x} \sqrt{{T}_{x 1}}}{{p}_{to}} ) .$$

In other words:

$${u}_{BV}^{LP} = {f}_{1} ( {\overline{N}}_{t}^{NP} , \frac{{W}_{x} \sqrt{{T}_{x 1}}}{{p}_{to}} ) .$$

For a single stage turbocharger, Tₓ₁=Tₓ, where Tₓ is an exhaust temperature.

The desired LP turbo speed (N̅ₜ^{LP}) is based partially on at least one of a second look-up factor and a second polynomial function (ƒ₂ (x₁, x₂)) of a desired LP compressor pressure ratio (x₁=β̅_{c}^{LP}) and a modified compressor flow

$$( {x}_{2} = \frac{{W}_{C} \sqrt{{T}_{a}}}{{p}_{a}} ) .$$

Here, pₜₒ is a turbine outlet pressure, Tₓ₁=Tₓ is an exhaust temperature, Wₓ is an exhaust flow, pₐ is an ambient pressure, Tₐ is an ambient temperature and W_{c} is a fresh air flow. For a single stage turbocharger, there is no mid-exhaust temperature, thus Tₓ₁=Tₓ, where T₁ is defined as a mid-exhaust temperature and Tₓ is the exhaust temperature.
In one example

$${\overline{N}}_{t}^{LP} = \sqrt{{T}_{a}} {f}_{2} ( {\overline{β}}_{c}^{LP} , \frac{{W}_{C} \sqrt{{T}_{a}}}{{p}_{a}} ) .$$

Alternatively, the controller C may be configured to determine the first valve optimal position (u_{BV}^{LP}) as at least one of a third look-up factor and a third polynomial function (ƒ₃ (x₁, x₂)) of a modified LP compressor power

$$( {x}_{1} = \frac{{\overline{P}}_{w}^{LP}}{{p}_{to} \sqrt{{T}_{x 1}}} )$$

and a modified total exhaust flow

$$( {x}_{2} = \frac{{W}_{x} \sqrt{{T}_{x}}}{{p}_{to}} ) .$$

In other words:

$${u}_{BV}^{LP} = {f}_{3} ( \frac{{\overline{P}}_{w}^{LP}}{{p}_{to} \sqrt{{T}_{x 1}}} , \frac{{W}_{x} \sqrt{{T}_{x 1}}}{{p}_{to}} ) .$$

Here P̅_{w}^{LP} is an LP compressor power, pₜₒ is a turbine outlet pressure, Tₓ₁=Tₓ is an exhaust temperature, and Wₓ is an exhaust flow. The LP compressor power (P̅_{w}^{LP}) may be determined based at least partially on an LP compressor transfer rate (R_{c}^{LP}), an ambient temperature (Tₐ), a fresh air flow (W_{c}) and a specific heat capacity (cₚ) such that: P̅_{w}^{LP}=W_{C}cₚTₐR_{c}^{LP}. The LP compressor transfer rate (R_{c}^{LP}) may be determined as at least one of a fourth look-up factor and a fourth polynomial function (ƒ₄ (x₁, x₂)) of a desired LP compressor pressure ratio (x₁=β̅_{c}^{LP}) and a modified compressor flow

$$( {x}_{2} = \frac{{W}_{C} \sqrt{{T}_{a}}}{{p}_{a}} ) .$$

In other words:

$${R}_{c}^{LP} = {f}_{4} ( {\overline{β}}_{c}^{LP} , \frac{{W}_{C} \sqrt{{T}_{a}}}{{p}_{a}} ) .$$

In block 108 of FIG. 2, the controller C is programmed to control the output (such as the torque output) of the engine 14 by commanding one or more of the valves 28, 38 of the engine 14 to their respective optimal position. Referring to FIG. 3, the Command Unit 218 (per block 108) commands the first valve 28 to the first valve optimal position (u_{BV}^{LP}) in order to control the output of the engine 14.

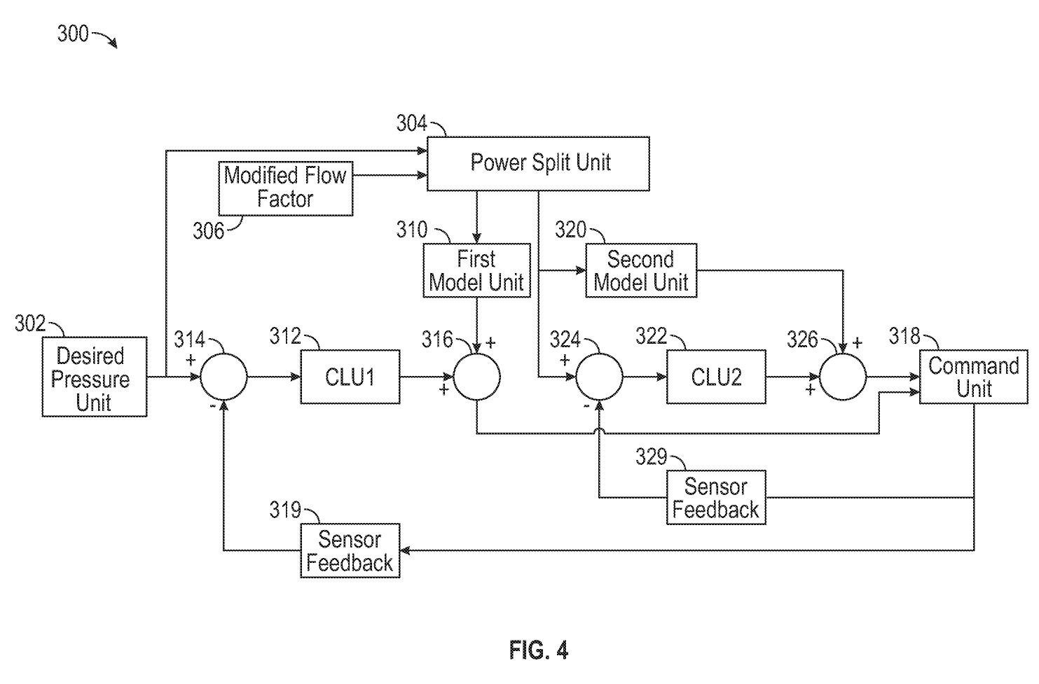

In accordance with a second embodiment, a second control structure 300 is shown in FIG. 4 for a two-stage turbocharger system. The second control structure 300 is configured to execute blocks 101, 102, 103, 104, 105, 106, 107 and 108 of method 100 of FIG. 2. In the second embodiment, the method 100 may begin with block 101, where the controller C is programmed to obtain a power-split distribution or ratio based at least partially on the desired total compressor pressure ratio (β̅_{c}). The power-split distribution is characterized by a desired LP compressor pressure ratio (β̅_{c}^{LP}) and a desired HP compressor pressure ratio (β̅_{c}^{HP}). The power-split distribution may be characterized as:

$$( {\overline{β}}_{c} ) = \frac{{p}_{i}}{{p}_{a}} = {β}_{C}^{LP} {β}_{C}^{HP} ; power \text{-} split ratio = ( \frac{{\overline{β}}_{c}^{LP} - 1}{{\overline{β}}_{c} - 1} ) .$$

Referring to FIG. 4, a Power Split Unit 304 receives the following as inputs: a modified flow factor 306

$$( \frac{{W}_{C} \sqrt{{T}_{a}}}{{p}_{a}} )$$

and the desired total compressor pressure ratio (β̅_{c}) from a Desired Pressure Unit 302. Per block 101, the Power Split Unit 304 outputs a desired LP compressor pressure ratio (β̅_{c}^{LP}), which is fed into a First Model Unit 310.

From block 101, the method 100 proceeds to both blocks 102 and 103. Per block 102 of FIG. 2 and referring to FIG. 4, the First Model Unit 310 produces a first model output, which is fed into a Second Summation Unit 316. In block 103 of FIG. 2, the controller C is configured to obtain a second model output from a second model based at least partially on the desired HP compressor pressure ratio (β̅_{c}^{HP}). Referring to FIG. 4, the Power Split Unit 304 outputs a desired HP compressor pressure ratio (β̅_{c}^{HP}) into a Second Model Unit 320 and a Third Summation Unit 324. Per block 103 of FIG. 2 and referring to FIG. 4, the Second Model Unit 320 produces a second model output, which is fed into a Fourth Summation Unit 326.

Per block 104 of FIG. 2 and referring to FIG. 4, a First Closed Loop Unit 312 (“CLU1” in FIG. 4) is configured to determine a first delta factor based at least partially on the desired total compressor pressure ratio (β̅_{c}) and the sensor feedback 319 (via a First Summation Unit 314). Referring to FIG. 4, the Desired Pressure Unit 302 obtains and feeds the desired total compressor pressure ratio (β̅_{c}) into the First Summation Unit 314, which subsequently feeds the First Closed Loop Unit 312. The First Summation Unit 314 receives sensor feedback 319 from the plurality of sensors 50 of FIG. 1. The Closed Loop Unit 312, 322 may be proportional-integral-derivative (PID) units, a model predictive control units (MPC) or other closed loop units available to those skilled in the art.

In block 105 of FIG. 2, the controller C is programmed to obtain a second delta factor based at least partially on the desired HP compressor pressure ratio (β̅_{c}^{HP}) and the sensor feedback 329. The second delta factor represents a change in position of the second valve 38 that minimizes the difference between the desired total compressor pressure ratio (β̅_{c}) and the actual total compressor pressure ratio (β̅_{c}). Referring to FIG. 4, per block 105 of FIG. 2, a Second Closed Loop Unit 312 (“CLU2” in FIG. 4) is configured to determine a second delta factor (via the Third Summation Unit 324) based at least partially on the desired HP compressor pressure ratio (β̅_{c}^{HP}) and the sensor feedback 329 from the plurality of sensors 50.

Per block 106 of FIG. 2 and referring to FIG. 4, the Second Summation Unit 316 is configured to sum the output of the Closed Loop Unit 312 (the first delta factor) and the output of the First Model Unit 310 (the first model output) to determine the first valve optimal position (u_{BV}^{LP}), which is inputted into a Command Unit 318. As described above, the first valve position (u_{BV}^{LP}) may be determined as:

$${u}_{BV}^{LP} = {f}_{1} ( {\overline{N}}_{t}^{LP} , \frac{{W}_{x} \sqrt{{T}_{x 1}}}{{p}_{to}} ) , where {\overline{N}}_{t}^{LP} = \sqrt{{T}_{a}} {f}_{2} ( {\overline{β}}_{c}^{LP} , \frac{{W}_{C} \sqrt{{T}_{a}}}{{p}_{a}} ) . \\ {u}_{BV}^{LP} = {f}_{3} ( \frac{{\overline{P}}_{w}^{LP}}{{p}_{to} \sqrt{{T}_{x 1}}} , \frac{{W}_{x} \sqrt{{T}_{x 1}}}{{p}_{to}} ) , where {\overline{P}}_{w}^{LP} = {W}_{C} {c}_{p} {T}_{a} {R}_{c}^{LP} and {R}_{c}^{LP} = {f}_{4} ( {\overline{β}}_{c}^{LP} , \frac{{W}_{C} \sqrt{{T}_{a}}}{{p}_{a}} ) . \\$$

In block 107 of FIG. 2, the controller C is programmed to obtain a second valve optimal position (u_{BV}^{HP}) based at least partially on the second model output and the second delta factor, i.e., on a sum of the second model output and the second delta factor. Per block 107 of FIG. 2 and referring to FIG. 4, the Fourth Summation Unit 326 is configured to sum the output of a Second Closed Loop Unit 322 (the second delta factor) and the output of the Second Model Unit 320 (the second model output) to determine the second valve optimal position (u_{BV}^{HP}), which is inputted into the Command Unit 318.

The controller C may be configured to determine the second valve optimal position (u_{BV}^{HP}) as at least one of a fifth look-up factor and a fifth polynomial function (Is (x₁, x₂)) of a desired HP turbo speed (x₁=N̅ₜ^{HP}) and a modified total exhaust flow

$$( {x}_{2} = \frac{{W}_{x} \sqrt{{T}_{x}}}{{p}_{x 1}} ) ,$$

where pₓ₁ is a mid-turbine pressure, Tₓ₁ is an mid-exhaust temperature, Wₓ is an exhaust flow. In other words:

$${u}_{BV}^{HP} = {f}_{5} ( {\overline{N}}_{t}^{HP} , \frac{{W}_{x} \sqrt{{T}_{x}}}{{p}_{x 1}} ) .$$

The desired HP turbo speed (N̅ₜ^{HP}) is based in part on at least one of a sixth look-up factor and a sixth polynomial function (ƒ₆ (x₁, x₂)) of a desired HP compressor pressure ratio (x₁=β̅_{c}^{HP}) and a modified fresh air flow

$$( {x}_{2} = \frac{{W}_{C} \sqrt{{T}_{1}}}{{\overline{β}}_{c}^{LP} {p}_{a}} ) ,$$

where pₐ is an ambient pressure, T₁ is an LP compressor outlet temperature and W_{c} is a fresh air flow. In one example:

$${\overline{N}}_{t}^{HP} = \sqrt{{T}_{1}} {f}_{6} ( {\overline{β}}_{c}^{HP} , \frac{{W}_{C} \sqrt{{T}_{1}}}{{\overline{β}}_{c}^{LP} {p}_{a}} ) .$$

Alternatively, the controller C may be configured to determine the second valve optimal position (u_{BV}^{HP}) as at least one of a seventh look-up factor and a seventh polynomial function (ƒ₇ (x₁, x₂)) of a modified HP compressor power

$$( {x}_{1} = \frac{{\overline{P}}_{w}^{HP}}{{p}_{x 1} \sqrt{{T}_{x}}} )$$

and a modified total exhaust flow

$$( {x}_{2} = \frac{{W}_{x} \sqrt{{T}_{x}}}{{p}_{x 1}} ) .$$

Here P̅_{w}^{HP} is a HP compressor power, pₓ₁ is a mid-exhaust pressure, Tₓ is an exhaust temperature, Wₓ is an exhaust flow and Tₓ is an exhaust temperature. In other words:

$${u}_{BV}^{HP} = {f}_{7} ( \frac{{\overline{P}}_{w}^{HP}}{{p}_{x 1} \sqrt{{T}_{x}}} , \frac{{W}_{x} \sqrt{{T}_{x}}}{{p}_{x 1}} ) .$$

The HP compressor power (P̅_{w}^{HP}) may be determined based at least partially on an HP compressor transfer rate (R_{c}^{HP}), an ambient temperature (Tₐ) and a fresh air flow (W_{c}). In one example: P̅_{w}^{HP}=W_{C}cₚT₁R_{c}^{HP}. The HP compressor transfer rate (R_{c}^{HP}) may be obtained as at least one of an eighth look-up factor and an eighth polynomial function (ƒ₈ (x₁, x₂)) of a desired HP compressor pressure ratio (x₁×β̅_{c}^{HP}) and a modified fresh air flow

$$( {x}_{2} = \frac{{W}_{C} \sqrt{{T}_{1}}}{{\overline{β}}_{c}^{LP} {p}_{a}} ) .$$

Here T₁ is an LP compressor outlet temperature and pₐ is an ambient pressure. Thus:

$${R}_{c}^{HP} = {f}_{8} ( {\overline{β}}_{c}^{HP} , \frac{{W}_{C} \sqrt{{T}_{1}}}{{\overline{β}}_{c}^{LP} {p}_{a}} ) .$$

From both blocks 106 and 107, the method 100 proceeds to block 108, where the controller C is programmed to control the output of the engine 14 by commanding one or more of the valves of the engine 14 to their respective optimal position. Referring to FIG. 4, the Command Unit 318 commands the first and second valves 28, 38 to their respective optimal positions (per block 108 of FIG. 2) in order to control the output of the engine 14. The controller C may be configured to employ virtual sensors to estimate mid-exhaust temperature (Tₓ₁), mid-exhaust pressure (pₓ₁) and LP compressor outlet temperature (T₁) as follows:

T₁=Tₐ+R_{C}^{LP}Tₐ; pₓ₁=PₜₒG₂(P̅_{w}^{LP}); or pₓ₁=PₜₒG₁(N̅ₜ^{LP}).

Here, G₁ and G₂ are look-up functions or polynomials and R_{C}^{LP} is a LP compressor transfer rate.

In summary, the first valve position (u_{BV}^{LP}) may be determined by equations (1) and (2) below and the second valve position (u_{BV}^{LP}) may be determined by equations (3) and (4) below:

$$\begin{matrix}{u}_{BV}^{LP} = {f}_{1} ( {\overline{N}}_{t}^{LP} , \frac{{W}_{x} \sqrt{{T}_{x 1}}}{{p}_{to}} ) , & Equation ( 1 ) \\ where {\overline{N}}_{t}^{LP} = \sqrt{{T}_{a}} {f}_{2} ( {\overline{β}}_{c}^{LP} , \frac{{W}_{C} \sqrt{{T}_{a}}}{{p}_{a}} ) . & \\ {u}_{BV}^{LP} = {f}_{3} ( \frac{{\overline{P}}_{w}^{LP}}{{p}_{to} \sqrt{{T}_{x 1}}} , \frac{{W}_{x} \sqrt{{T}_{x 1}}}{{p}_{to}} ) , & Equation ( 2 ) \\ where {\overline{P}}_{w}^{LP} = {W}_{C } {c}_{p} {T}_{a} {R}_{c}^{LP} and & \\ {R}_{c}^{LP} = {f}_{4} ( {\overline{β}}_{c}^{LP} , \frac{{W}_{C} \sqrt{{T}_{a}}}{{p}_{a}} ) . & \\ {u}_{BV}^{HP} = {f}_{5} ( {\overline{N}}_{t}^{HP} , \frac{{W}_{x} \sqrt{{T}_{x}}}{{p}_{x 1}} ) , & Equation ( 3 ) \\ where {\overline{N}}_{t}^{HP} = \sqrt{{T}_{1}} {f}_{6} ( {\overline{β}}_{c}^{HP} , \frac{{W}_{C} \sqrt{{T}_{1}}}{{\overline{β}}_{c}^{LP} {p}_{a}} ) . & \\ {u}_{BV}^{HP} = {f}_{7} ( \frac{{\overline{P}}_{w}^{HP}}{{p}_{x 1} \sqrt{{T}_{x }}} , \frac{{W}_{x} \sqrt{{T}_{x}}}{{p}_{x 1}} ) , & Equation ( 4 ) \\ where {\overline{P}}_{w}^{HP} = {W}_{C } {c}_{p} {T}_{1} {R}_{c}^{HP} and & \\ {R}_{c}^{HP} = {f}_{8} ( {\overline{β}}_{c}^{HP} , \frac{{W}_{C} \sqrt{{T}_{1}}}{{\overline{β}}_{c}^{LP} {p}_{a}} ) . & \end{matrix}$$

The method 100 applies unique energy balanced turbocharger models to design feed forward controllers for both by-pass valves, and may employ single or two-loop feedback controls to deliver the final engine boost pressure for achieving system robustness in tracking performances. Two energy balanced models are designed for feed forward controls: desired corrected compressor power based, and desired corrected turbo speed based. The power split between the two-stage turbochargers are optimized to achieve the fast acceleration or best charging efficiency resulting minimum engine pumping loss. The mode switching between acceleration and fuel economy modes is decided by pedal and or change of pedal positions.

The method 100 provides a systematic approach to optimize and design the control systems for single and two-stage turbocharged engines by using unique model based approaches, thus reducing calibration significantly. The approach can optimize the charging system, delivering fast boost tracking performance during the transients and improved fuel economy. The model may be embedded into a vehicle control unit as part of the controller C with minimal calibration efforts.

The controller C of FIG. 1 may be an integral portion of, or a separate module operatively connected to, other controllers of the device 10, such as the engine controller. The controller C includes a computer-readable medium (also referred to as a processor-readable medium), including any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above, and may be accessed via a network in any one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An engine assembly comprising:
an engine and a first turbine operatively connected to the engine;
a first valve configured to modulate flow to the first turbine and a controller configured to transmit a primary command signal to the first valve;
at least one sensor configured to transmit a sensor feedback to the controller;
wherein the controller has a processor and a tangible, non-transitory memory on which instructions are recorded, execution of the instructions by the processor causing the controller to:
obtain a first model output based at least partially on a desired total compressor pressure ratio (β̅_{c});
obtain a first delta factor based at least partially on the desired total compressor pressure ratio (β̅_{c}) and the sensor feedback;
obtain a first valve optimal position (u_{BV}^{LP}) for the first valve based at least partially on the first model output and the first delta factor; and
control an output of the engine by commanding the first valve to the first valve optimal position (u_{BV}^{LP}), via the primary command signal.

2. The assembly of claim 1, wherein the controller is configured to:
determine the first valve optimal position (u_{BV}^{LP}) as at least one of a first look-up factor and a first polynomial function (ƒ₁ (x₁, x₂)) of a desired LP turbo speed (x₁=N̅ₜ^{LP}) and a modified total exhaust flow
$$( {x}_{2} = \frac{{W}_{x} \sqrt{{T}_{x 1}}}{{p}_{to}} ) ,$$
where pₜₒ is a turbine outlet pressure, Tₓ₁ is a mid-exhaust temperature and Wₓ is an exhaust flow; and
determine the desired LP turbo speed (N̅ₜ^{LP}) based partially on at least one of a second look-up factor and a second polynomial function (ƒ₂ (x₁, x₂)) of a desired LP compressor pressure ratio (x₁=β̅_{c}^{LP}) and a modified compressor flow
$$( {x}_{2} = \frac{{W}_{C} \sqrt{{T}_{a}}}{{p}_{a}} ) ,$$
where pₐ is an ambient pressure, Tₐ is an ambient temperature and W_{c} is a fresh air flow.

3. The assembly of claim 1, wherein the controller is configured to:
determine the first valve optimal position (u_{BV}^{LP}) as at least one of a third look-up factor and a third polynomial function (ƒ₃ (x₁, x₂)) of a modified LP compressor power
$$( {x}_{1} = \frac{{\overline{P}}_{w}^{LP}}{{p}_{to} \sqrt{{T}_{x 1}}} )$$
and a modified total exhaust flow
$$( {x}_{2} = \frac{{W}_{x} \sqrt{{T}_{x 1}}}{{p}_{to}} ) ,$$
where P̅_{w}^{LP} is an LP compressor power, pₜₒ is a turbine outlet pressure, Tₓ₁ is a mid-exhaust temperature, Wₓ is an exhaust flow and Tₓ is an exhaust temperature.

4. The assembly of claim 3, wherein the controller is configured to:
determine the LP compressor power (P̅_{w}^{LP}) based at least partially on an LP compressor transfer rate (R_{c}^{LP}), an ambient temperature (Tₐ) and a fresh air flow (W_{c}); and
determine the LP compressor transfer rate (R_{c}^{LP}) as at least one of a fourth look-up factor and a fourth polynomial function (ƒ₄ (x₁, x₂)) of a desired LP compressor pressure ratio (x₁=β̅_{c}^{LP}) and a modified compressor flow
$$( {x}_{2} = \frac{{W}_{C} \sqrt{{T}_{a}}}{{p}_{a}} ) .$$

5. The assembly of claim 1, further comprising:
a second turbine operatively connected to the first turbine, the first turbine being a relatively high pressure turbine and the second turbine being a relatively low pressure turbine;
a second valve configured to modulate flow to the second turbine, the controller being configured to transmit a secondary command signal to the second valve;
wherein the controller is further configured to:
obtain a power-split distribution based at least partially on the desired total compressor pressure ratio (δ̅_{c}), the power-split distribution being characterized by a desired LP compressor pressure ratio (β̅_{c}^{LP}) and a desired HP compressor pressure ratio (β̅_{c}^{HP});
obtain a second model output based at least partially on the desired HP compressor pressure ratio (β̅_{c}^{HP});
obtain a second delta factor based at least partially on the desired HP compressor pressure ratio (β̅_{c}^{HP}) and the sensor feedback;
obtain a second valve optimal position (u_{BV}^{HP}) based at least partially on the second model output and the second delta factor; and
control the output of the engine by commanding the second valve to the second valve optimal position (u_{BV}^{HP}), via the secondary command signal.

6. The assembly of claim 5, wherein the controller is configured to determine:
the second valve optimal position (u_{BV}^{HP}) as at least one of a fifth look-up factor and a fifth polynomial function (ƒ₅ (x₁, x₂)) of a desired HP turbo speed (x₁=N̅ₜ^{HP}) and a modified total exhaust flow
$$( {x}_{2} = \frac{{W}_{x} \sqrt{{T}_{x}}}{{p}_{x 1}} ) ,$$
where pₓ₁ is a mid-turbine pressure, Tₓ₁ is an mid-exhaust temperature, Wₓ is an exhaust flow; and
the desired HP turbo speed (N̅ₜ^{HP}) based in part on at least one of a sixth look-up factor and a sixth polynomial function (ƒ₆ (x₁, x₂)) of a desired HP compressor pressure ratio (x₁=β̅_{c}^{HP}) and a modified fresh air flow
$$( {x}_{2} = \frac{{W}_{C} \sqrt{{T}_{1}}}{{\overline{β}}_{c}^{LP} {p}_{a}} ) ,$$
where pₐ is an ambient pressure, T₁ is an LP compressor outlet temperature and W_{c} is a fresh air flow.

7. The assembly of claim 5, wherein the controller is configured to:
determine the second valve optimal position (u_{BV}^{HP}) as at least one of a seventh look-up factor and a seventh polynomial function (ƒ₇ (x₁, x₂)) of a modified HP compressor power
$$( {x}_{1} = \frac{{\overline{P}}_{w}^{HP}}{{p}_{x 1} \sqrt{{T}_{x}}} )$$
and a modified total exhaust flow
$$( {x}_{2} = \frac{{W}_{x} \sqrt{{T}_{x}}}{{p}_{x 1}} ) ,$$
where P̅_{w}^{HP} is a HP compressor power, pₓ₁ is a mid-exhaust pressure, Tₓ is an exhaust temperature and Wₓ is an exhaust flow.

8. The assembly of claim 7, wherein:
the controller is configured to determine the HP compressor power (P̅_{w}^{HP}) based at least partially on an HP compressor transfer rate (R_{c}^{HP}), an ambient temperature (Tₐ) and a fresh air flow (W_{c}); and
the controller is configured to determine the HP compressor transfer rate (R_{c}^{HP}) as at least one of an eighth look-up factor and an eighth polynomial function (ƒ₈ (x₁, x₂)) of a desired HP compressor pressure ratio (x₁=β̅_{c}^{HP}) and a modified fresh air flow
$$( {x}_{2} = \frac{{W}_{C} \sqrt{{T}_{1}}}{{\overline{β}}_{c}^{LP} {p}_{a}} ) ,$$
where T₁ is an LP compressor outlet pressure and pₐ is an ambient pressure.

9. A method of controlling an output of an engine assembly having an engine, a first turbine operatively connected to the engine, a first valve configured to modulate flow to the first turbine, a controller configured to transmit a primary command signal to the first valve, and at least one sensor configured to transmit a sensor feedback to the controller, the controller having a processor and a tangible, non-transitory memory on which is recorded instructions, the method comprising:
obtaining a first model output based at least partially on a desired total compressor pressure ratio (β̅_{c});
obtaining a first delta factor based at least partially on the desired total compressor pressure ratio (β̅_{c}) and the sensor feedback;
obtaining a first valve optimal position (u_{BV}^{LP}) based at least partially on the first model output and the first delta factor; and
controlling the output of the engine by commanding the first valve to the first valve optimal position (u_{BV}^{LP}), via the primary command signal.

10. The method of claim 9, wherein obtaining the first valve optimal position (u_{BV}^{LP}) includes:
determining the first valve optimal position (u_{BV}^{LP}) as at least one of a first look-up factor and a first polynomial function (ƒ₁ (x₁, x₂)) of a desired LP turbo speed (x₁=N̅ₜ^{LP}) and a modified total exhaust flow
$$( {x}_{2} = \frac{{W}_{x} \sqrt{{T}_{x 1}}}{{p}_{to}} ) ;$$
and
determining the desired LP turbo speed as at least one of a second look-up factor and a second polynomial function (ƒ₂ (x₁, x₂)) of a desired LP compressor pressure ratio (x₁=β̅_{c}^{LP}) and a modified compressor flow
$$( {x}_{2} = \frac{{W}_{C} \sqrt{{T}_{a}}}{{p}_{a}} ) ,$$
where pₜₒ is a turbine outlet pressure, Tₓ₁ is a mid-exhaust temperature, Wₓ is an exhaust flow, pₐ is an ambient pressure, Tₐ is an ambient temperature and W_{c} a fresh air flow.

11. The method of claim 9, wherein obtaining the first valve optimal position (u_{BV}^{LP}) includes:
determining the first valve optimal position (u_{BV}^{LP}) as at least one of a third look-up factor and a third polynomial function (ƒ₃ (x₁, x₂)) of a modified LP compressor power
$$( {x}_{1} = \frac{{\overline{P}}_{w}^{LP}}{{p}_{to} \sqrt{{T}_{x 1}}} )$$
and a modified total exhaust flow
$$( {x}_{2} = \frac{{W}_{x} \sqrt{{T}_{x}}}{{p}_{to}} ) ,$$
where P̅_{w}^{LP} is an LP compressor power, pₜₒ is a turbine outlet pressure, Tₓ₁ is an mid-exhaust temperature, Wₓ is an exhaust flow and Tₓ is an exhaust temperature.

12. The method of claim 9, further comprising:
determining the LP compressor power (P̅_{w}^{LP}) based at least partially on an LP compressor transfer rate (R_{c}^{LP}), an ambient temperature (Tₐ) and a fresh air flow (W_{c}); and
determining the LP compressor transfer rate (R_{c}^{LP}) as at least one of a fourth look-up factor and a fourth polynomial function (ƒ₄ (x₁, x₂)) of a desired LP compressor pressure ratio (x₁=β̅_{c}^{LP}) and a modified compressor flow
$$( {x}_{2} = \frac{{W}_{C} \sqrt{{T}_{a}}}{{p}_{a}} ) .$$

13. The method of claim 9, wherein the assembly includes a second turbine operatively connected to the first turbine and a second valve configured to modulate flow to the second turbine, the first turbine being a relatively high pressure turbine and the second turbine being a relatively low pressure turbine, the controller being configured to transmit a secondary command signal to the second valve, the method further comprising:
obtaining a power-split distribution based at least partially on the desired total compressor pressure ratio (β̅_{c}), the power-split distribution being characterized by a desired LP compressor pressure ratio (β̅_{c}^{LP}) and a desired HP compressor pressure ratio (β̅_{c}^{HP});
obtaining a second model output based at least partially on the desired HP compressor pressure ratio (β̅_{c}^{HP});
obtaining a second delta factor based at least partially on the desired HP compressor pressure ratio (β̅_{c}^{HP}) and the sensor feedback;
obtaining a second valve optimal position (u_{BV}^{HP}) based at least partially on the second model output and the second delta factor; and
controlling an output of the engine by commanding the second valve to the second valve optimal position (u_{BV}^{HP}), via the controller.

14. The method of claim 13, further comprising:
determining the second valve optimal position (u_{BV}^{HP}) as at least one of a fifth look-up factor and a fifth polynomial function (ƒ₅ (x₁, x₂)) of a desired HP turbo speed (x₁=N̅ₜ^{HP}) and a modified total exhaust flow
$$( {x}_{2} = \frac{{W}_{x} \sqrt{{T}_{x}}}{{p}_{x 1}} ) ,$$
where pₓ₁ is a mid-exhaust pressure, Tₓ is an exhaust temperature and Wₓ is an exhaust flow; and
determining the desired HP turbo speed (N̅ₜ^{HP}) based in part on at least one of a sixth look-up factor and a sixth polynomial function (ƒ₆ (x₁, x₂)) of a desired HP compressor pressure ratio (x₁=β̅_{c}^{HP}) and a modified fresh air flow
$$( {x}_{2} = \frac{{W}_{C} \sqrt{{T}_{1}}}{{\overline{β}}_{c}^{LP} {p}_{a}} ) ,$$
where pₐ is an ambient pressure, T₁ is an LP compressor outlet temperature and W_{c} a fresh air flow.

15. The method of claim 13, further comprising:
determining the second valve optimal position (u_{BV}^{HP}) as at least one of a seventh look-up factor and a seventh polynomial function (ƒ₇ (x₁, x₂)) of a modified HP compressor power
$$( {x}_{1} = \frac{{\overline{P}}_{w}^{HP}}{{p}_{x 1} \sqrt{{T}_{x}}} )$$
and a modified total exhaust flow
$$( {x}_{2} = \frac{{W}_{x} \sqrt{{T}_{x}}}{{p}_{x 1}} ) ,$$
where P̅_{w}^{HP} is a HP compressor power, pₓ₁ is a mid-exhaust pressure, Tₓ is an exhaust temperature and Wₓ is an exhaust flow.

16. The method of claim 15, further comprising:
determining the HP compressor power (P̅_{w}^{HP}) based at least partially on an HP compressor transfer rate (R_{c}^{HP}), an ambient temperature (Tₐ) and a fresh air flow (W_{c});
determining the HP compressor transfer rate (R_{c}^{HP}) as at least one of an eighth look-up factor and an eighth polynomial function (ƒ₈ (x₁, x₂)) of a desired HP compressor pressure ratio (x₁=β̅_{c}^{HP}) and a modified fresh air flow
$$( {x}_{2} = \frac{{W}_{C} \sqrt{{T}_{1}}}{{\overline{β}}_{c}^{LP} {p}_{a}} ) ,$$
where T₁ is an LP compressor outlet pressure and pₐ is an ambient pressure.

17. An engine assembly comprising:
an engine and a first turbine operatively connected to the engine;
a second turbine operatively connected to the first turbine, the first turbine being a relatively high pressure turbine and the second turbine being a relatively low pressure turbine;
a first valve configured to modulate flow to the first turbine and a controller configured to transmit a primary command signal to the first valve;
a second valve configured to modulate flow to the second turbine, the controller being configured to transmit a secondary command signal to the second valve;
at least one sensor configured to transmit a sensor feedback to the controller;
wherein the controller has a processor and a tangible, non-transitory memory on which instructions are recorded, execution of the instructions by the processor causing the controller to:
obtain a power-split distribution based at least partially on a desired total compressor pressure ratio (β̅_{c}), the power-split distribution being characterized by a desired LP compressor pressure ratio (β̅_{c}^{LP}) and a desired HP compressor pressure ratio (β̅_{c}^{HP});
obtain a first model output based at least partially on the desired total compressor pressure ratio (β̅_{c}) and a second model output based at least partially on the desired HP compressor pressure ratio (β̅_{c}^{HP});
obtain a first delta factor based at least partially on the desired total compressor pressure ratio (β̅_{c}) and the sensor feedback;
obtain a second delta factor based at least partially on the desired HP compressor pressure ratio (β̅_{c}^{HP}) and the sensor feedback;
obtain a first valve optimal position (u_{BV}^{LP}) for the first valve based at least partially on the first model output and the first delta factor;
obtain a second valve optimal position (u_{BV}^{HP}) based at least partially on the second model output and the second delta factor; and
control an output of the engine by commanding the first valve to the first valve optimal position (u_{BV}^{LP}) via the primary command signal and the second valve to the second valve optimal position (u_{BV}^{HP}) via the secondary command signal.
